(19) United States
(12) Patent Application Publication
(10) Pub. No.: US 2026/0060235 A1
(43) Pub. Date: Mar. 5, 2026

(54) LASER REPELLENT SYSTEM USING IMAGE RECOGNITION AND LASER REPELLENT DEVICE THEREOF

(71) Applicant: Hsing-Chung LIU, Taichung City (TW)

(72) Inventors: Hsing-Chung LIU, Taichung City (TW); Shao-De LIU, Taichung City (TW)

(21) Appl. No.: 19/313,429

(22) Filed: Aug. 28, 2025

(30) Foreign Application Priority Data
Aug. 30, 2024 (TW) 113132883

(51) Int. Cl. A01M 29/10; G03B 17/56; G06T 7/20; G06T 7/55; H01S 3/101; H04N 23/661; H04N 23/695

(52) U.S. Cl. CPC A01M 29/10; G03B 17/561; G06T 7/20; G06T 7/55; H01S 3/101; H04N 23/661; H04N 23/695; G06T 2207/10016; G06T 2207/20084; G06T 2207/30188; G06T 2207/30241

(57) ABSTRACT

A laser repellent device includes: an image capturing unit that is placed to face an area of interest, and, when activated, continuously captures images of the area of interest; a laser unit that includes a rotational module and a laser module, the laser module being configured to emit a laser beam and a direction of the laser beam being driven by the rotational module; and a processing unit that transmits the images of the area of interest to a server, receives an image recognition result generated by the server processing the images of the area of interest, generates a rotational signal and a laser activation signal based on the image recognition result, and transmits the rotational signal to the rotational module, and transmits the laser activation signal to the laser module, so as to control the operations of the rotational module and the laser module.

### CROSS-REFERENCE TO RELATED APPLICATION

This application claims priority to Taiwanese Invention patent application No. 113132883, filed on Aug. 30, 2024, the entire disclosure of which is incorporated by reference herein.

### FIELD

The disclosure relates to a repellent device, more particularly to a laser repellent system using image recognition and a laser repellent device thereof.

### BACKGROUND

Generally, a repellent device is to be disposed in specific areas that need to keep wild animals (e.g., birds) away, such as a farmland, an orchard, etc. Many different repellent devices adopt different manners to attempt to repel the animals, so as to protect the crops. One of the manners involves using laser to repel the animals.

A conventional laser repellent device includes a standing rod, a horizontal rotational component that is disposed rotatably on the standing rod, and a laser module that is disposed on the horizontal rotational component and that includes a housing, a vertical rotational component contained in the housing, and a plurality of laser emitting components disposed on the vertical rotational component. The horizontal rotational component is configured to drive the laser module to swing horizontally, and the vertical rotational component is configured to drive the laser module to swing vertically. As such, the laser emitting components may be activated periodically in an irregular manner, and emit laser in different directions in an attempt to scare the animals away.

It is noted that when using the conventional laser repellent device, more likely than not, the laser is emitted aimlessly without hitting the intended targets, therefore causing the energy used for emitting the laser to be wasted.

### SUMMARY

Therefore, one object of the disclosure is to provide a laser repellent device using image recognition that can alleviate at least one of the drawbacks of the prior art.

According to one embodiment of the disclosure, the laser repellent device is disposed in an area of interest and is configured to communicate with a server. The laser repellent device includes an image capturing unit, a laser unit and a processing unit.

The image capturing unit is placed to face the area of interest, and is configured to continuously capture images of the area of interest in real time. The laser unit includes a rotational module and a laser module disposed on the rotational module. The laser module is configured to emit a laser beam and to be driven by the rotational module to rotate so as to change a direction of the laser beam. The processing unit is electrically connected to the image capturing unit, the rotational module and the laser module.

The processing unit is configured to, in response to receipt of the images of the area of interest from the image capturing unit, transmit the images of the area of interest to the server for the server to process the images of the area of interest, to generate an image recognition result and to transmit the image recognition result to the processing unit. In response to receipt of the image recognition result, the processing unit generates a rotational signal and a laser activation signal based on the image recognition result, transmits the rotational signal to the rotational module, and transmits the laser activation signal to the laser module, so as to control the operations of the rotational module and the laser module.

Another object of the disclosure is to provide a laser repellent system that includes the above-mentioned laser repellent device.

According to one embodiment of the disclosure, the laser repellent system includes a laser repellent device disposed in an area of interest and a server communicating with the laser repellent device. The laser repellent device includes an image capturing unit, a laser unit and a processing unit.

The image capturing unit is placed to face the area of interest, and is configured to continuously capture images of the area of interest in real time. The laser unit includes a rotational module and a laser module disposed on the rotational module. The laser module is configured to emit a laser beam and to be driven by the rotational module to rotate so as to change a direction of the laser beam. The processing unit is electrically connected to the image capturing unit, the rotational module and the laser module.

The processing unit, in response to receipt of the images of the area of interest from the image capturing unit, transmits the images of the area of interest to the server. The server, in response to receipt of the images of the area of interest, processes the images of the area of interest to generate an image recognition result and transmits the image recognition result to the processing unit. In response to receipt of the image recognition result, the processing unit generates a rotational signal and a laser activation signal based on the image recognition result, transmits the rotational signal to the rotational module, and transmit the laser activation signal to the laser module, so as to control the operations of the rotational module and the laser module.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a block diagram of a laser repellent system using image recognition according to one embodiment of the disclosure.

FIG. 2 is a schematic view illustrating an exemplary laser repellent device mounted in an exemplary area of interest that includes a fish pond according to one embodiment of the disclosure.

FIG. 3 is a flow chart illustrating steps of a method for operating the laser repellent system according to one embodiment of the disclosure.

FIG. 4 is a block diagram of a laser repellent system using image recognition according to one embodiment of the disclosure.

FIG. 5 is a schematic view illustrating an exemplary laser repellent device being mounted in an exemplary area of interest that includes a crop land according to one embodiment of the disclosure.

FIG. 6 is a flow chart illustrating steps of a method for operating the laser repellent system according to one embodiment of the disclosure.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

Throughout the disclosure, the term “coupled to” or “connected to” may refer to a direct connection among a plurality of electrical apparatus/devices/equipment via an electrically conductive material (e.g., an electrical wire), or an indirect connection between two electrical apparatus/devices/equipment via another one or more apparatus/devices/equipment, or wireless communication.

It should be noted herein that for clarity of description, spatially relative terms such as “top,” “bottom,” “upper,” “lower,” “on,” “above,” “over,” “downwardly,” “upwardly” and the like may be used throughout the disclosure while making reference to the features as illustrated in the drawings. The features may be oriented differently (e.g., rotated 90 degrees or at other orientations) and the spatially relative terms used herein may be interpreted accordingly.

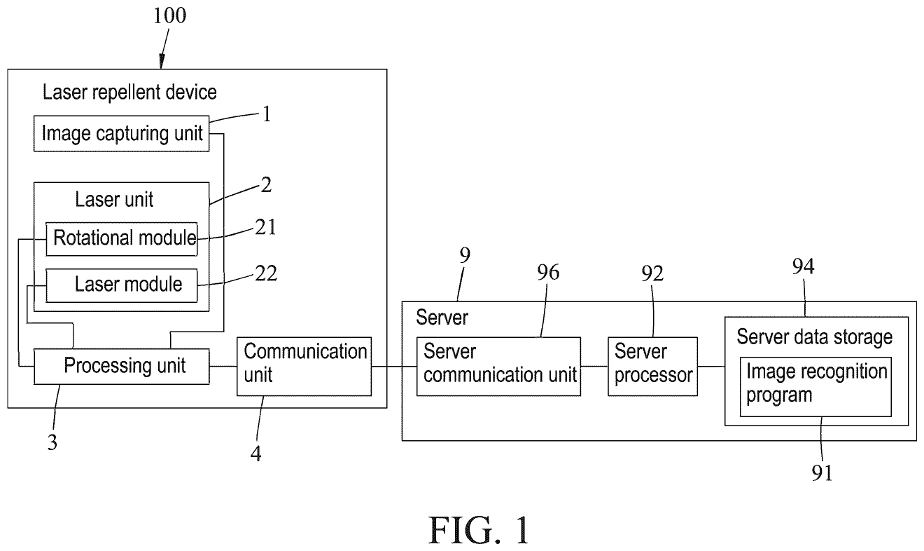

FIG. 1 is a block diagram of a laser repellent system 10 using image recognition according to one embodiment of the disclosure. In this embodiment, the laser repellent system includes a laser repellent device 100 and a server 9. The laser repellent device 100 is to be disposed at an area of interest, and is in communication with the server 9. Typically, the area of interest may be an agricultural land or an aquaculture area.

The laser repellent device 100 includes an image capturing unit 1, a laser unit 2, a processing unit 3, and a communication unit 4.

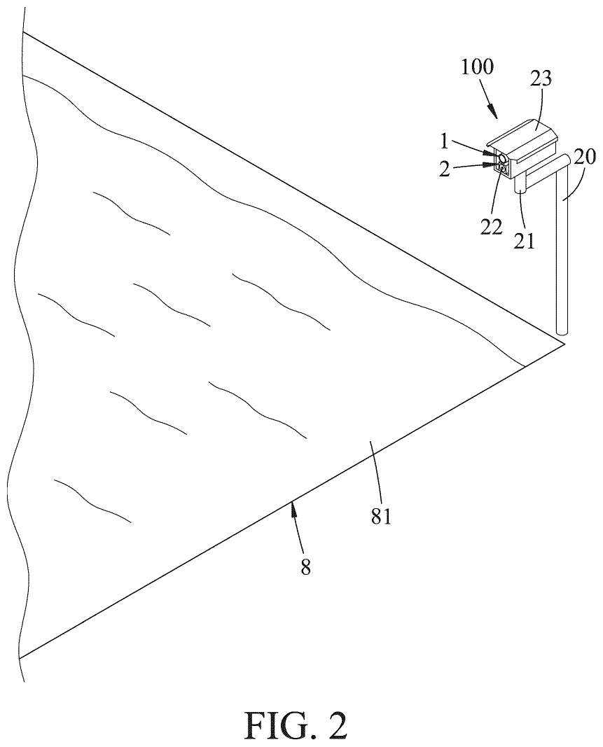

FIG. 2 illustrates an exemplary embodiment of the laser repellent device 100 mounted in an exemplary area of interest 8. For example, the area of interest 8 includes a fish pond 81.

In this embodiment, the image capturing unit 1 may be embodied using a camera, is placed to face the area of interest 8, and is configured to continuously capture images of the area of interest 8 in real time. The laser unit 2 includes a standing rod 20 mounted on the ground of the area of interest 8, a rotational module 21 mounted on the standing rod 20, a laser module 22 disposed on the rotational module 21, and a housing 23 that is disposed above and covers the rotational module 21. The image capturing unit 1 and the laser module 22 are mounted on the rotational module 21 and disposed in the housing 23.

In some embodiments, the rotational module 21 may be embodied using an integrated rotary table that supports two-axis rotary functions, and that complies with the EIA-485 (also known as RS-485) standard, but is not limited to such. It is noted that in embodiments, the rotational module 21 may be configured to drive the image capturing unit 1 and the laser module 22 to rotate separately.

The laser module 22 includes one or more laser emitting lights. The laser emitting lights are configured to emit a laser beam of specific wavelengths, and the laser module 22 is driven by the rotational module 21 to rotate so as to change a direction of the laser beam. In this embodiment, the laser emitting lights are configured to emit green laser beams.

The housing 23 may be embodied using a waterproof housing that accommodates the image capturing unit 1 and the laser module 22 therein.

The processing unit 3 is electrically connected to the image capturing unit 1, the rotational module 21 and the laser module 22, and may be embodied using a central processing unit (CPU), a microprocessor, a microcontroller, a single core processor, a multi-core processor, a dual-core mobile processor, a digital signal processor (DSP), a field-programmable gate array (FPGA), an application specific integrated circuit (ASIC), a system on chip (SoC), and/or a radio-frequency integrated circuit (RFIC), etc . . . .

The communication unit 4 is electrically connected to the processing unit 3, and may include one or more of a radio-frequency integrated circuit (RFIC), a short-range wireless communication module supporting a short-range wireless communication network using a wireless technology of Bluetooth® and/or Wi-Fi, etc., and a mobile communication module supporting telecommunication using Long-Term Evolution (LTE), the third generation (3G) of, the fourth generation (4G) of or the fifth generation (5G) of wireless mobile telecommunications technology, or the like.

The processing unit 3 receives, from the image capturing unit 1, the images of the fish pond 81 captured by the image capturing unit 1, and transmits the images to the server 9 through the communication unit 4. The processing unit 3 further controls the operations of the rotational module 21 and the laser module 22.

The server 9 may be embodied using a server device, a personal computer, a laptop, or other suitable electronic devices, and includes a server processor 92, a server data storage 94, and a server communication unit 96.

The server processor 92 may be embodied using components that are similar to the processing unit 3. The server data storage 94 may be embodied using, for example, random access memory (RAM), read only memory (ROM), programmable ROM (PROM), firmware, flash memory, or other suitable non-transitory storage medium. The server communication unit 96 may be embodied using components that are similar to the communication unit 4.

The server data storage 94 stores an image recognition program 91 therein. In embodiments, the image recognition program 91 includes a convolutional neural network model such as various versions of You Only Look Once (YOLO) or other suitable image recognition algorithms, and may include other software programs that, when executed by the server processor 92, cause the server processor 92 to implement the operations as described below.

In use, the laser repellent system may be operated in order to scare away animals such as a bird that comes near the fish pond 81, so as to prevent the animals from catching the fish in the fish pond 81 or contaminating the fish pond 81.

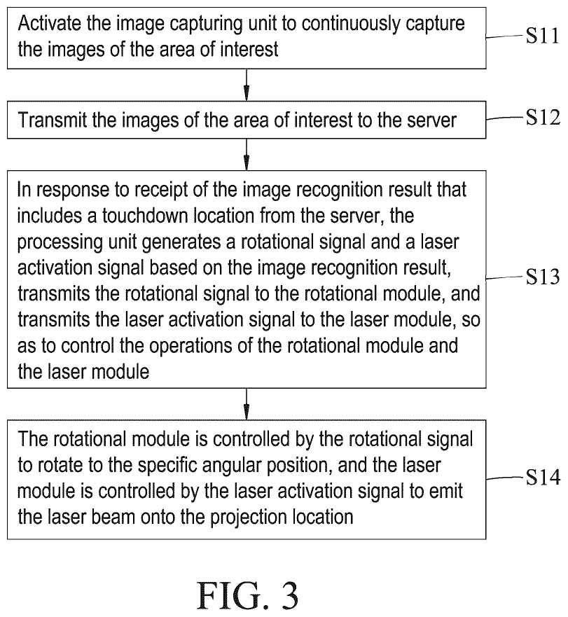

FIG. 3 is a flow chart illustrating steps of a method for operating the laser repellent system according to one embodiment of the disclosure. In the embodiment of FIG. 3, the method is implemented using the laser repellent system as shown in FIGS. 1 and 2.

In step S11, the processing unit 3 controls the rotational module 21 to rotate, such that the image capturing unit 1 rotates together with the rotational module 21 to face the fish pond 81. Then, the processing unit 3 activates the image capturing unit 1 to continuously capture the images of the area of interest 8 that includes the fish pond 81 in real time.

In step S12, the processing unit 3 receives the images of the area of interest 8 from the image capturing unit 1, and transmits the images of the area of interest 8 to the server 9 through the communication unit 4.

In response to receipt of the images of the area of interest 8, the server processor 92 executes the image recognition program 91 to process the images, and generates an image recognition result. The server processor 92 first executes the image recognition program 91 to detect objects in the images of the area of interest 8, and determines whether the images of the area of interest 8 includes one or more target objects (e.g., birds). When determining that the images of the area of interest 8 includes one or more target objects, the server processor 92 then generates the image recognition result based on the detection result determined by the image recognition program 91. In embodiments, the image recognition result includes, for each of the target objects, a touchdown location which may be an inbound touchdown location that is on the fish pond 81 or an outbound touchdown location that is not on the fish pond 81.

Specifically, based on consecutive images of the area of interest 8, the server processor 92 executing the image recognition program 91 recognizes the target objects. In this embodiments, the image recognition program 91 is for recognizing the birds appearing in the images as the target objects, and based on the locations of the target objects in the images, the server processor 92 is configured to obtain a trajectory for each of the target objects, and to obtain the touchdown location for each of the target objects based on the corresponding trajectory. The touchdown location indicates a location at which the corresponding bird is expected to land and touch the ground or land on the fish pond 81, contacting a water surface of the fish pond 81. In the case that the expected location of the target object is above the fish pond 81 (that is, contacting the water surface of the fish pond 81), a corresponding inbound touchdown location is generated in the form of a set of coordinates with respect to a reference three-dimensional (3D) coordinate system. In the case that the expected location of the target object is within the area of interest 8 but not above the fish pond 81 (e.g., on the ground), a corresponding outbound touchdown location is generated in the form of a set of coordinates with respect to the reference 3D coordinate system.

In one example, two target objects may be recognized in the images by the server processor 92, and based on the two trajectories respectively of the two target objects, one of the corresponding birds may be determined to be stopping above the fish pond 81 on the water surface, indicating that this bird may be attempting to catch fish in the fish pond 81. The other one of the corresponding birds may be determined to be stopping at another place in the area of interest 8 (e.g., in a field beside the fish pond 81), indicating that this bird may be resting and/or excreting. It is noted that the excretion of the birds may carry germs or viruses harmful to the fish in the fish pond 81, and it is undesirable for the excretion of the birds to drop into the fish pond 81 directly or through rainfall. In this example, the image recognition result is generated to include both an inbound touchdown location and an outbound touchdown location.

In another example, one target object may be recognized in the images by the server processor 92, and based on the trajectory, the corresponding bird may be determined to be stopping at another place in the area of interest 8, rather than the fish pond 81, which indicates that this bird may be resting and/or excreting. In this example, the image recognition result is generated to only include an outbound touchdown location.

In another example, more than two target objects may be recognized in the images by the server processor 92, and based on multiple trajectories respectively of the target objects, two or more birds may be determined to be stopping above the fish pond 81 on the water surface, indicating that these birds may be attempting to catch fish in the fish pond 81. Two or more birds may be determined to be stopping at other places in the area of interest 8, rather than the fish pond 81, which indicates that these birds may be resting and/or excreting. In this example, the image recognition result is generated to include multiple inbound touchdown locations and/or multiple outbound touchdown locations.

As such, the server processor 92 is configured to generate the image recognition result that includes, for each of the target objects, one of the inbound touchdown location and the outbound touchdown location. Then, the server processor 92 transmits the image recognition result to the processing unit 3 through the server communication unit 96. In the case that the images of the area of interest 8 do not include any target object, the server processor 92 will not generate the image recognition result. Therefore, the processing unit 3 of the laser repellent device 100 will not receive the same and will continue to execute step S12.

In step S13, in response to receipt of the image recognition result from the server 9, the processing unit 3 generates a rotational signal and a laser activation signal based on the image recognition result, transmits the rotational signal to the rotational module 21, and transmits the laser activation signal to the laser module 22, so as to control the operations of the rotational module 21 and the laser module 22.

Specifically, for each touchdown location included in the image recognition result, the rotational signal is calculated to cause the rotational module 21 to rotate to a specific angular position where the laser module 22 faces a three-dimensional (3D) specific direction toward the touchdown location. The laser activation signal activates the laser module 22, so as to cause the laser module 22 to emit the laser beam in the specific direction, such that the laser is projected onto a projection location that corresponds with the touchdown location.

Then, in step S14, the rotational module 21 is controlled by the rotational signal to rotate to the specific angular position, and the laser module 22 is controlled by the laser activation signal to emit the laser beam onto the projection location. In use, the projection location may be identical to the touchdown location, in order to directly project the laser beam onto the bird. In the case that the area of interest 8 includes the fish pond 81, the laser beam projected onto the inbound touchdown location causes glare to not only scare the bird away, but also disrupt the fish nearby, causing the fish to scatter away from the inbound touchdown location.

In the case that multiple touchdown locations (including inbound touchdown locations and/or outbound touchdown locations) are included in the image recognition result, the processing unit 3 may generate multiple sets of rotational signal and laser activation signal that correspond with the touchdown locations, respectively, and transmit each of the sets of rotational signal and laser activation signal to the rotational module 21 and the laser module 22 in a sequentially manner. For example, a first set of rotational signal and laser activation signal may be first transmitted, causing the laser module 22 to emit a laser beam onto a first projection location that corresponds with a first one of the touchdown locations. After a predetermined time has elapsed (e.g., 15 seconds), a second set of rotational signal and laser activation signal may be transmitted, causing the laser module 22 to emit a laser beam onto a second projection location that corresponds with a second one of the touchdown locations. The above steps may be repeated for the remaining touchdown locations.

It is noted that after activating the laser module 22 for a time period, the processing unit 3 may generate and transmit a laser deactivation signal to the laser module 22, in order to deactivate the laser module 22. In this manner, the laser module 22 is controlled to activate to emit laser beam at a precise location, and deactivate after a time period, therefore reducing unnecessary power usage.

In brief, the embodiments as shown in FIGS. 1 to 3 provide a laser repellent system using image recognition that is suitable for use in an area of interest including a fish pond. By determining the inbound touchdown location and/or the outbound touchdown location of the bird near the area of interest, the processing unit may generate the rotational signal and the laser activation signal to cause the laser module to emit the laser beam accurately at the bird, in order to scare away the bird that attempts to catch the fish in the fish pond or that is excreting near the fish pond.

It is noted that in embodiments, the processing unit 3 may include hardware components that are configured to implement the image recognition operations of the server 9, and therefore the server 9 may be omitted.

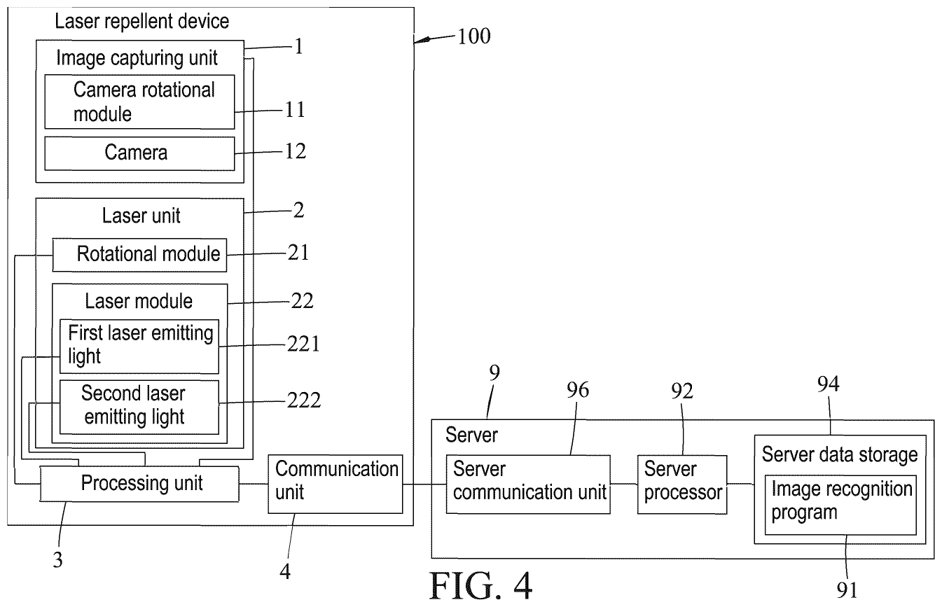

FIG. 4 is a block diagram of a laser repellent system using image recognition according to one embodiment of the disclosure. In this embodiment, the laser repellent system includes a laser repellent device 100 and a server 9. The laser repellent device 100 is to be disposed at an area of interest, and is in communication with the server 9. Typically, the area of interest may be an agricultural land or an aquaculture area.

The laser repellent device 100 includes an image capturing unit 1, a laser unit 2, a processing unit 3, and a communication unit 4.

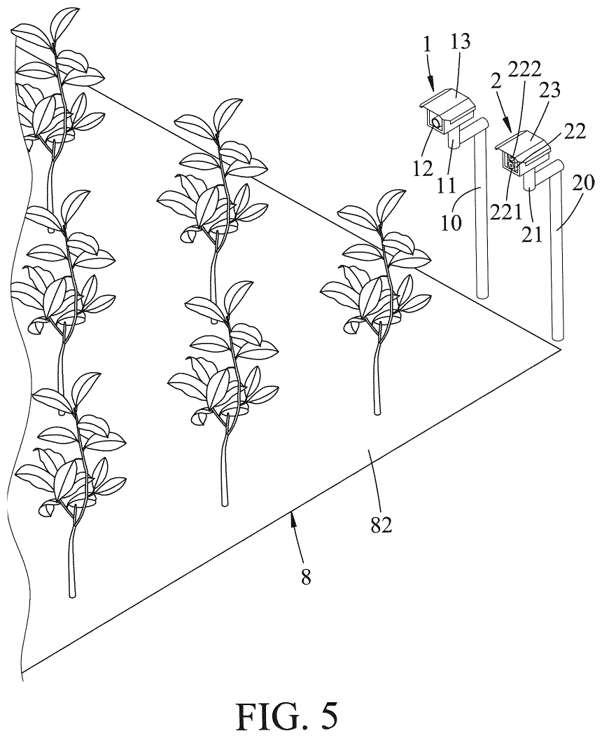

FIG. 5 illustrates an exemplary embodiment of the laser repellent device 100 mounted in an exemplary area of interest 8. For example, the area of interest 8 includes a crop land 82.

In this embodiment, the image capturing unit 1 includes a camera standing rod 10 mounted on the ground of the area of interest 8, a camera rotational module 11 mounted on the camera standing rod 10, a camera 12 disposed on the camera rotational module 11, and a camera housing 13 that is disposed above and covers the camera rotational module 11. The camera 12 is disposed in the camera housing 13.

In some embodiments, the camera rotational module 11 may be embodied using an integrated rotary table that supports two-axis rotary functions, and that complies with the EIA-485 (also known as RS-485) standard, but is not limited to such.

The camera 12 may be embodied using a high-magnification zoom camera, and when activated, is configured to continuously capture images of the crop land 82 in real time.

The camera housing 13 may be embodied using a waterproof housing that accommodates the camera 12 therein.

The laser unit 2 includes a standing rod 20 mounted on the ground of the area of interest 8, a rotational module 21 mounted on the standing rod 20, a laser module 22 disposed on the rotational module 21, and a housing 23 that is disposed above and covers the rotational module 21. The laser module 22 is disposed in the housing 23. In the embodiment of FIG. 4, the image capturing unit 1 and the laser unit 2 are mounted separately.

It is noted that in embodiments, the rotational module 21 is configured to drive the image capturing unit 1 and the laser module 22 to rotate separately. In some embodiments, the rotational module 21 may be embodied using an integrated rotary table that supports two-axis rotary functions (e.g., horizontally and vertically), and that complies with the EIA-485 (also known as RS-485) standard, but is not limited to such.

The laser module 22 includes one or more laser emitting lights. Specifically, the laser module 22 includes a first laser emitting light 221 and a second laser emitting light 222 that emit laser beams with different wavelengths. In this embodiment, the first laser emitting light 221 is configured to emit a green laser beam, and the second laser emitting light 222 is configured to emit a blue laser beam.

The housing 23 may be embodied using a waterproof housing that accommodates the laser module 22 therein.

The processing unit 3 is electrically connected to the camera rotational module 11, the camera 12, the rotational module 21 and the laser module 22, and stores a first distance threshold, a second distance threshold that is shorter than the first distance threshold, and a cutoff distance threshold that is larger than the first distance threshold. In embodiments, the first distance threshold is in a range of about 50 meters to 100 meters, the second distance threshold is in a range of about 10 meters to 15 meters, and the cutoff distance threshold is in a range of about 250 meters to 350 meters.

The communication unit 4 is electrically connected to the processing unit 3. The processing unit 3 receives, from the image capturing unit 1, the images of the crop land 82 captured by the image capturing unit 1, and transmits the images to the server 9 through the communication unit 4. The processing unit 3 further controls the operations of the camera rotational module 11, the camera 12, the rotational module 21 and the laser module 22.

The server 9 may be embodied using a server device, a personal computer, a laptop, or other suitable electronic devices, and includes a server processor 92, a server data storage 94, and a server communication unit 96.

The server data storage 94 stores an image recognition program 91 therein. In embodiments, the image recognition program 91 includes a convolutional neural network model such as various versions of YOLO or other suitable image recognition algorithms.

In use, the laser repellent system may be operated in order to scare away animals such as an ape that comes near the crop land 82, so as to prevent the animals from taking crops in the crop land 82.

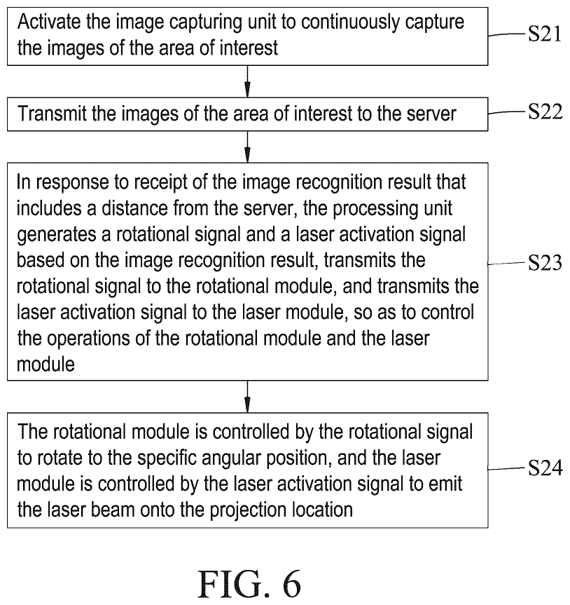

FIG. 6 is a flow chart illustrating steps of a method for operating the laser repellent system according to one embodiment of the disclosure. In the embodiment of FIG. 6, the method is implemented using the laser repellent system as shown in FIGS. 4 and 5.

In step S21, the processing unit 3 controls the camera rotational module 11 to rotate, such that the camera 12 rotates together with the camera rotational module 11 to face the area of interest 8. Then, the processing unit 3 activates the camera 12 of the image capturing unit 1 to continuously capture the images of the area of interest 8 in real time.

In step S22, the processing unit 3 receives the images of the area of interest 8 from the image capturing unit 1, and transmits the images of the crop land 82 to the server 9 through the communication unit 4.

In response to receipt of the images of the area of interest 8, the server processor 92 executes the image recognition program 91 to generate an image recognition result. The server processor 92 first executes the image recognition program 91 to detect objects in the images of the area of interest 8, and determines whether the images of the area of interest 8 includes one or more target objects (e.g., animals). When determining that the images of the area of interest 8 includes one or more target objects, the server processor 92 then generates the image recognition result based on the detection result determined by the image recognition program 91. In embodiments, the image recognition result includes, for each of the target objects, a current location of the target object and a distance between the current location of the target object and the crop land 82.

Specifically, based on consecutive images of the area of interest 8, the server processor 92 executing the image recognition program 91 recognizes the target objects. In this embodiment, the image recognition program 91 is for recognizing animals appearing in the images as the target objects, and based on the locations of the target objects in the images, the server processor 92 is configured to obtain the current location for each of the target objects, and obtain the distance based on the corresponding current location. Then, the server processor 92 transmits the image recognition result to the processing unit 3 through the server communication unit 96. In the case that the images of the area of interest 8 do not include any target object, the server processor 92 will not generate the image recognition result. Therefore, the processing unit 3 of the laser repellent device 100 will not receive the same and will continue to execute step S22.

In step S23, in response to receipt of the image recognition result from the server 9, the processing unit 3 generates a rotational signal and a laser activation signal based on the image recognition result, transmits the rotational signal to the rotational module 21, and transmits the laser activation signal to the laser module 22, so as to control the operations of the rotational module 21 and the laser module 22.

Specifically, for each target object, the rotational signal is calculated to cause the rotational module 21 to rotate to a specific angular position where the laser module 22 faces a 3D specific direction toward the current location included in the image recognition result. The laser activation signal activates the laser module 22, so as to cause one of the first laser emitting light 221 and the second laser emitting light 222 of the laser module 22 to emit a corresponding laser beam in the specific direction, such that the laser beam is projected onto the current location of the object.

It is noted that based on the distance between the target object and the crop land 82, different operations may be implemented. Specifically, in the case that the processing unit 3 determines that the distance is between the first distance threshold and the second distance threshold, the processing unit 3 generates the laser activation signal for activating the first laser emitting light 221, causing the laser module 22 to emit a green laser beam, such that the green laser beam is projected onto the current location of the target object. In this case, the green laser beam is aimed to cause a glaring effect to scare away the animal since the animal is within a distance that is near but not very close to the crop land 82, indicating a potential but not yet imminent threat to the crop land 82.

On the other hand, in the case that the processing unit 3 determines that the distance is shorter than the second distance threshold, the processing unit 3 generates the laser activation signal for activating the second laser emitting light 222, causing the laser module 22 to emit a blue laser beam, such that the blue laser beam is projected onto the current location of the target object. In this case, the blue laser beam is aimed to forcefully drive away the animal since the animal is very close to the crop land 82, indicating an imminent threat to the crop land 82. As the blue laser beam has a higher energy density than the green laser beam, when projected onto the animal, the blue laser beam causes a burning sensation that forces the animal to move away from the crop land 82.

Then, in step S24, the rotational module 21 is controlled by the rotational signal to rotate to the specific angular position, and the laser module 22 is controlled by the laser activation signal to emit the laser beam onto the projection location. In use, the projection location may be identical to the current location of the target object.

Then, in step S25, after activating the laser module 22, the processing unit 3 determines whether there is no longer a target object near the crop land 82 for a time period. That is, the processing unit 3 determines whether the distance included in the image recognition result continues to be larger than the cutoff distance threshold for the time period (i.e., the animal has moved sufficiently away from the crop land 82). In the case that it is determined that there is no longer a target object within the cutoff distance to the crop land 82 for the time period, the processing unit 3 generates a laser deactivation signal and transmits the laser deactivation signal to the laser module 22, in order to deactivate the laser module 22. In this manner, the laser module 22 is controlled to activate to emit laser beam at a precise location when a threat appears, and deactivate after the threat disappears for a time period, therefore reducing unnecessary power usage.

In brief, the embodiments as shown in FIGS. 4 to 6 provide a laser repellent system using image recognition that is suitable for use in an area of interest including a crop land. By determining a distance between an animal and the crop land, the processing unit may generate the rotational signal and the laser activation signal to cause the laser module to emit different laser beams accurately at the animal, in order to scare away the animal that comes near the crop land using the green laser beam, or to directly project the blue laser beam onto the animal to force them away from the crop land.

It is noted that in embodiments, the processing unit 3 may include hardware components that are configured to implement the image recognition operations of the server 9, and therefore the server 9 may be omitted.

In some embodiments, the configuration of the laser repellent device 100 as shown in FIG. 5 may be adopted in the area of interest 8 of FIG. 2.

To sum up, embodiments of the disclosure provide a laser repellent system using image recognition that employs an image capturing unit to capture images of an area of interest, and to process the images to recognize the target objects included in the images, in order to determine whether a laser beam needs to be projected to a specific location. In the case that a laser beam needs to be projected to a specific location, a processing unit controls a rotational module to rotate so as to cause a laser module to face a specific direction, and to activate the laser module to emit a laser beam to be projected to the specific location. In this manner, the laser module may be controlled to accurately project the laser beam to scare away or force away animals. As such, the laser repellent system can be operated with significantly reduced power consumption.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is (are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A laser repellent device disposed in an area of interest and configured to communicate with a server, the laser repellent device comprising:
an image capturing unit that is placed to face the area of interest, and that is configured to continuously capture images of the area of interest in real time;
a laser unit that includes a rotational module and a laser module disposed on the rotational module, the laser module being configured to emit a laser beam and to be driven by the rotational module to rotate so as to change a direction of the laser beam; and
a processing unit electrically connected to the image capturing unit,
the rotational module and the laser module,
wherein the processing unit is configured to,
in response to receipt of the images of the area of interest from the image capturing unit, transmit the images of the area of interest to the server for the server to process the images of the area of interest, to generate an image recognition result and to transmit the image recognition result to the processing unit,
in response to receipt of the image recognition result, generate a rotational signal and a laser activation signal based on the image recognition result, and
transmit the rotational signal to the rotational module, and transmit the laser activation signal to the laser module, so as to control the operations of the rotational module and the laser module.

2. The laser repellent device as claimed in claim 1, the area of interest including a fish pond, the server being configured to execute an image recognition program for recognizing a bird included in the images as a target object, the image recognition result including a touchdown location indicating a location at which the bird is expected to land and touch the ground,
wherein the processing unit generates the rotational signal and the laser activation signal based on the touchdown location.

3. The laser repellent device as claimed in claim 2, the touchdown location being one of an inbound touchdown location that is on the fish pond and an outbound touchdown location that is not on the fish pond,
wherein the processing unit generates the rotational signal and the laser activation signal in order to control the rotational module to drive the laser module to rotate to an angular position where the laser module faces a specific direction toward the touchdown location, such that the laser beam emitted by the laser module is projected onto a location that corresponds with the touchdown location.

4. The laser repellent device as claimed in claim 1, the area of interest including a crop land, the server being configured to execute an image recognition program for recognizing an animal included in the images as a target object, the image recognition result including a current location of the animal and a distance between the current location of the animal and the crop land, wherein:
the laser module includes a first laser emitting light configured to emit a green laser beam, and a second laser emitting light configured to emit a blue laser beam;
the laser activation signal generated by the processing unit activates one of the first laser emitting light and the second laser emitting light; and
the processing unit generates the rotational signal and the laser activation signal in order to control the rotational module to drive the laser module to rotate to an angular position where the laser module faces a specific direction toward the current location, such that the laser beam emitted by the one of the first laser emitting light and the second laser emitting light is projected onto the current location of the animal.

5. The laser repellent device as claimed in claim 4, wherein:
the processing unit stores a first distance threshold and a second distance threshold that is shorter than the first distance threshold; and
in the case that the processing unit determines that the distance included in the image recognition result is between the first distance threshold and the second distance threshold, the processing unit generates the laser activation signal for activating the first laser emitting light to emit the green laser beam.

6. The laser repellent device as claimed in claim 5, wherein:
in the case that the processing unit determines that the distance is shorter than the second distance threshold, the processing unit generates the laser activation signal for activating the second laser emitting light to emit the blue laser beam.

7. The laser repellent device as claimed in claim 6, wherein:
the processing unit further stores a cutoff distance threshold that is larger than the first distance threshold, and after activating the laser module, determines whether the distance is larger than the cutoff distance threshold; and
in the case that it is determined the distance is larger than the cutoff distance threshold for a time period, the processing unit generates a laser deactivation signal and transmits the laser deactivation signal to the laser module, in order to deactivate the laser module.

8. The laser repellent device as claimed in claim 7, wherein the first distance threshold is in a range of 50 to 100 meters, the second distance threshold is in a range of 10 to 15 meters, and the cutoff distance threshold is in a range of 250 to 350 meters.

9. The laser repellent device as claimed in claim 1, wherein the laser unit includes:
a standing rod that is mounted in the area of interest; and
a housing that is disposed above and covers the rotational module,
wherein the image capturing unit and the laser module are both mounted on the rotational module and are disposed in the housing.

10. The laser repellent device as claimed in claim 1, wherein the image capturing unit includes:
a camera standing rod mounted in the area of interest;
a camera rotational module mounted on the camera standing rod;
a camera disposed on the camera rotational module; and
a camera housing that is disposed above and covers the camera rotational module and that accommodates the camera therein.

11. A laser repellent system, comprising a laser repellent device disposed in an area of interest and a server communicating with the laser repellent device, the laser repellent device including:
an image capturing unit that is placed to face the area of interest, and that is configured to continuously capture images of the area of interest in real time;
a laser unit that includes a rotational module and a laser module disposed on the rotational module, the laser module being configured to emit a laser beam and to be driven by the rotational module to rotate so as to change a direction of the laser beam; and
a processing unit electrically connected to the image capturing unit,
the rotational module and the laser module, wherein:
the processing unit, in response to receipt of the images of the area of interest from the image capturing unit, transmits the images of the area of interest to the server;
the server, in response to receipt of the images of the area of interest, processes the images of the area of interest to generate an image recognition result and transmits the image recognition result to the processing unit,
in response to receipt of the image recognition result, the processing unit generates a rotational signal and a laser activation signal based on the image recognition result, transmits the rotational signal to the rotational module, and transmit the laser activation signal to the laser module, so as to control the operations of the rotational module and the laser module.

12. The laser repellent system as claimed in claim 11, the area of interest including a fish pond, wherein the server is configured to execute an image recognition program for recognizing a bird included in the images as a target object, and the image recognition result includes a touchdown location indicating a location at which the bird is expected to land and touch the ground,
wherein the processing unit generates the rotational signal and the laser activation signal based on the touchdown location.

13. The laser repellent system as claimed in claim 12, wherein:
the touchdown location is one of an inbound touchdown location that is on the fish pond and an outbound touchdown location that is not on the fish pond,
the processing unit generates the rotational signal and the laser activation signal in order to control the rotational module to drive the laser module to rotate to an angular position where the laser module faces a specific direction toward the touchdown location, such that the laser beam emitted by the laser module is projected onto a location that corresponds with the touchdown location.

14. The laser repellent system as claimed in claim 11, the area of interest including a crop land, wherein:
the server is configured to execute an image recognition program for recognizing an animal included in the images as a target object, the image recognition result includes a current location of the animal and a distance between the current location of the animal and the crop land:
the laser module includes a first laser emitting light configured to emit a green laser beam, and a second laser emitting light configured to emit a blue laser beam;
the laser activation signal generated by the processing unit activates one of the first laser emitting light and the second laser emitting light; and
the processing unit generates the rotational signal and the laser activation signal in order to control the rotational module to drive the laser module to rotate to an angular position where the laser module faces a specific direction toward the current location, such that the laser beam emitted by the one of the first laser emitting light and the second laser emitting light is projected onto the current location of the animal.

15. The laser repellent system as claimed in claim 14, wherein:
the processing unit stores a first distance threshold and a second distance threshold that is shorter than the first distance threshold; and
in the case that the processing unit determines that the distance included in the image recognition result is between the first distance threshold and the second distance threshold, the processing unit generates the laser activation signal for activating the first laser emitting light to emit the green laser beam.

16. The laser repellent system as claimed in claim 15, wherein:
in the case that the processing unit determines that the distance is shorter than the second distance threshold, the processing unit generates the laser activation signal for activating the second laser emitting light to emit the blue laser beam.

17. The laser repellent system as claimed in claim 16, wherein:
the processing unit further stores a cutoff distance threshold that is larger than the first distance threshold, and after activating the laser module, determines whether the distance is larger than the cutoff distance threshold; and
in the case that it is determined the distance is larger than the cutoff distance threshold for a time period, the processing unit generates a laser deactivation signal and transmits the laser deactivation signal to the laser module, in order to deactivate the laser module.

18. The laser repellent system as claimed in claim 17, wherein the first distance threshold is in a range of 50 to 100 meters, the second distance threshold is in a range of 10 to 15 meters, and the cutoff distance threshold is in a range of 250 to 350 meters.

19. The laser repellent system as claimed in claim 11, wherein the laser unit includes:
a standing rod that is mounted in the area of interest; and
a housing that is disposed above and covers the rotational module,
wherein the image capturing unit and the laser module are both mounted on the rotational module and are disposed in the housing.

20. The laser repellent system as claimed in claim 11, wherein the image capturing unit includes:
a camera standing rod mounted in the area of interest;
a camera rotational module mounted on the camera standing rod;
a camera disposed on the camera rotational module; and
a camera housing that is disposed above and covers the camera rotational module and that accommodates the camera therein.
